(19) United States
(12) Patent Application Publication
(10) Pub. No.: US 2013/0058032 A1
(43) Pub. Date: Mar. 7, 2013

(54) PORTABLE DATA STORAGE DEVICES AND HOSTS COMPLIANT WITH MULTIPLE COMMUNICATIONS STANDARDS

(71) Applicant: Jin-Young Jung, Hwaseong-si (KR)

(72) Inventor: Jin-Young Jung, Hwaseong-si (KR)

(73) Assignee: Samsung Electronics Co., Ltd.

(21) Appl. No.: 13/587,065

(22) Filed: Aug. 16, 2012

(30) Foreign Application Priority Data
Sep. 1, 2011 (KR) 10-2011-0088585

(51) Int. Cl. G06F 1/16

(52) U.S. Cl. 361/679.32

(57) ABSTRACT

Portable data storage devices can be provided that can include a substrate having a front surface on which a memory chip is mounted, first pads disposed on a back surface of the substrate opposite to the front surface, second pads disposed on the back surface of the substrate to be adjacent to the first pads, and protruding terminals disposed on respective ones of the second pads opposite to the substrate.

### CROSS-REFERENCE TO RELATED APPLICATIONS

This U.S. non-provisional patent application claims priority under 35 U.S.C. §119 to Korean Patent Application No. 10-2011-0088585, filed on Sept. 1, 2011, the disclosure of which is hereby incorporated by reference in its entirety.

### BACKGROUND

1. Technical Field

The present disclosure herein relates to portable data storage devices.

2. Description of Related Art

The Universal-Serial-Bus (USB) standard has been widely used as a standard bus for connecting peripherals devices, such as portable memory devices (e.g., portable data storage devices), printers and scanners to host computers.

USB 3.0 compliant devices have been standardized as a portable memory device. USB 3.0 compliant devices can provide a data transfer rate that is about ten times faster than that of the USB 2.0 compliant devices. For example, USB 3.0 compliant devices can provide a data transfer rate of about 5.0 GB/s ,whereas USB 2.0 compliant devices can provide a data transfer rate of about 480 MB/s. Further, USB 3.0 may be widely used as an interface to various electronic products that act as hosts, including computers.

### SUMMARY

Exemplary embodiments are directed to portable data storage devices.

In an exemplary embodiment, the portable data storage device includes a substrate having a front surface on which a memory chip is mounted, first pads disposed on a back surface of the substrate opposite to the front surface, second pads disposed on the back surface of the substrate to be adjacent to the first pads, and protruding terminals disposed on respective ones of the second pads opposite to the substrate.

Each of the protruding terminals may include a solder ball.

Each of the protruding terminals may include a first conductive layer and a second conductive layer. The first conductive layer may include a solder paste, and the second conductive layer may include one of copper, copper alloy, nickel and doped silicon.

Each of the protruding terminals may have a height of about 0.5 mm to about 0.6 mm.

The first pads may have a configuration that supports standard USB 2.0 devices.

The protruding terminals may have a configuration that supports standard USB 3.0 devices.

The memory chip may have a chip-on-board package structure.

The portable data storage device may further include a memory controller mounted on the front surface of the substrate and electrically connected to the memory chip.

The substrate may have a rectangular shape with a major axis parallel to a first direction and a minor axis parallel to a second direction, in a plan view. The first pads may be disposed to be spaced apart from each other in the second direction, and the second pads may be disposed to be spaced apart from each other in the second direction.

### BRIEF DESCRIPTION OF THE DRAWINGS

FIG. 1 is a perspective view illustrating a portable data storage device according to exemplary embodiments of the inventive concept.

FIG. 2 is a plan view illustrating a portable data storage device according to exemplary embodiments of the inventive concept.

FIGS. 3A through 3C are cross sectional views illustrating portable data storage devices according to some exemplary embodiments of the inventive concept.

FIG. 4 is a cross sectional view illustrating portable data storage devices according to exemplary embodiments of the inventive concept.

FIGS. 5A and 5B are cross sectional views illustrating methods of fabricating portable data storage device according to exemplary embodiments of the inventive concept.

FIG. 6 is a cross sectional view illustrating a combined state wherein a portable data storage device according to an exemplary embodiment is connected to a host.

### DESCRIPTION OF EMBODIMENTS ACCORDING TO THE INVENTIVE CONCEPT

Exemplary embodiments of the inventive concept are described below with reference to the accompanying drawings. Many different forms and exemplary embodiments of the inventive concept are possible without deviating from the spirit and teachings of this disclosure and so the disclosure should not be construed as limited to the exemplary embodiments of the inventive concept set forth herein. Rather, these exemplary embodiments of the inventive concept are provided so that this disclosure will be thorough and complete, and will convey the scope of the disclosure to those skilled in the art.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. In the drawings, the sizes and relative sizes of layers, elements, and regions may be exaggerated for clarity. Like reference numbers refer to like elements throughout.

Exemplary embodiments of the inventive concept are described herein with reference to perspective, cross sectional and plan views that are schematic illustrations of idealized exemplary embodiments. As such, variations from the shapes of the illustrations as a result, for example, of manufacturing techniques and/or tolerances, are to be expected. Thus, exemplary embodiments of the inventive concept may not be construed as limited to the particular shapes of regions illustrated herein but may be construed to include deviations in shapes that result, for example, from manufacturing.

It will be understood that, although the terms first, second, etc. may be used herein to describe various elements, these elements should not be limited by these terms. These terms are only used to distinguish one element from another. Thus, a first element could be termed a second element without departing from the teachings of the exemplary embodiments of the inventive concept.

As used herein the term “and/or” includes any and all combinations of one or more of the associated listed items. Exemplary embodiments explained and illustrated herein include their complementary counterparts.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which these embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

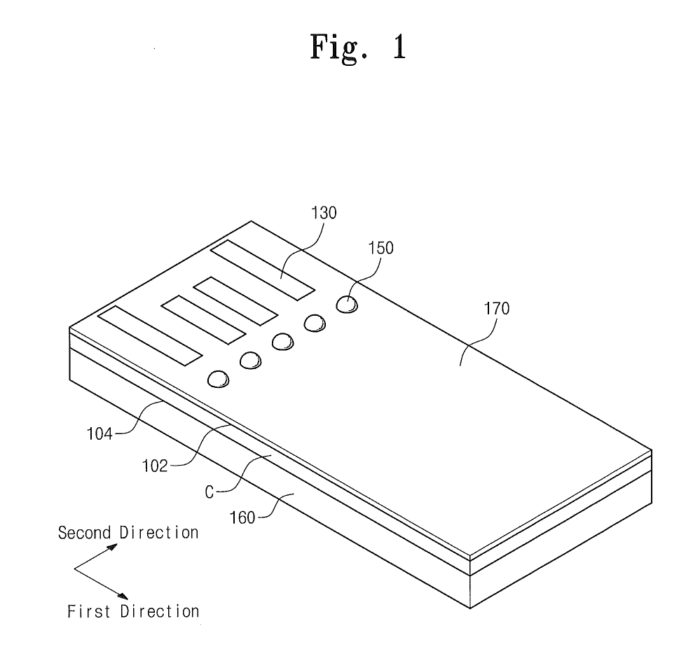

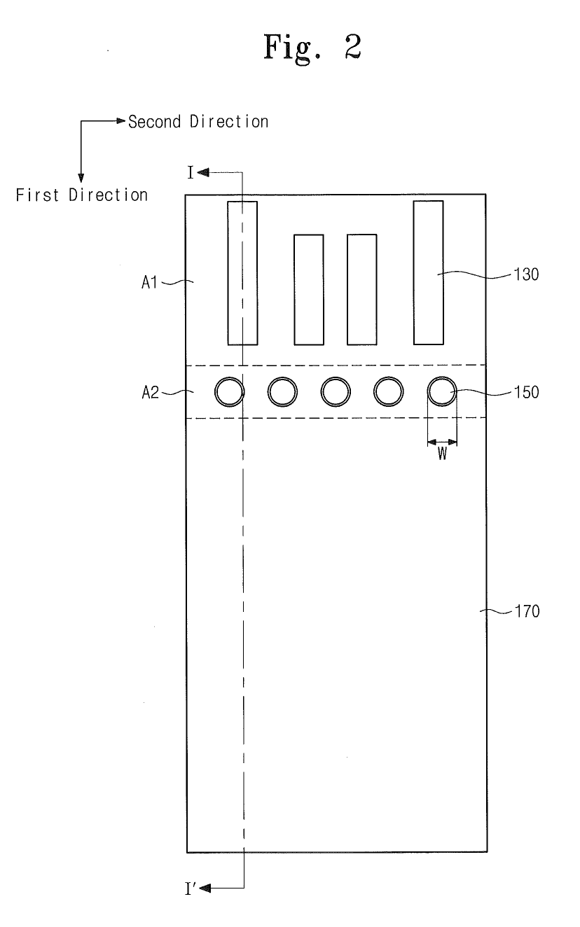

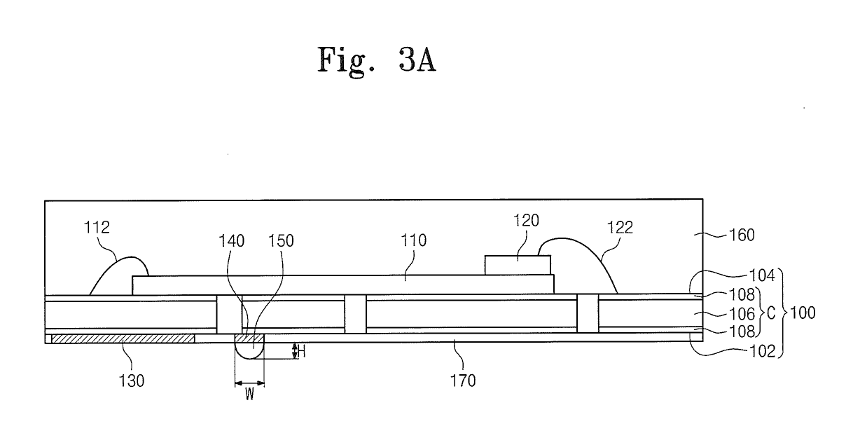

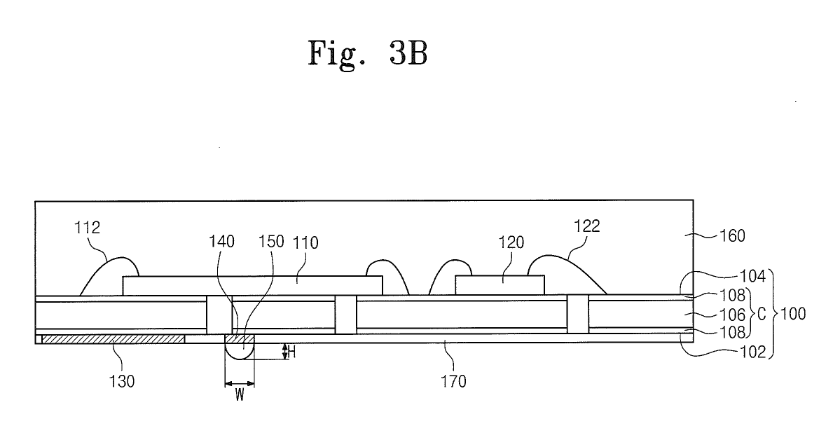

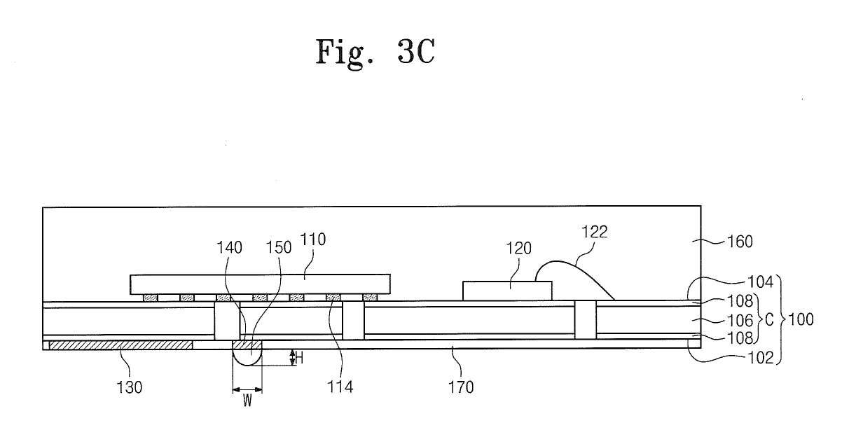

FIG. 1 is a perspective view illustrating a portable data storage device according to an exemplary embodiment, and FIG. 2 is a plan view illustrating a portable data storage device according to an exemplary embodiments of the inventive concept. FIGS. 3A through 3C are cross sectional views taken along a line I-I′ of FIG. 2 to illustrate portable data storage devices according to some exemplary embodiments of the inventive concept.

Referring to FIGS. 1, 2, 3A, 3B and 3C, a portable data storage device may include a substrate 100, a memory chip 110, a memory controller 120, first pads 130, second pads 140 and protruding terminals 150.

The substrate 100 may be a printed circuit board (PCB). The substrate 100 may include a core C disposed therein. The core C may include a pair of metal layers 108 and an insulation layer 106 between the pair of metal layers 108.

The substrate 100 may have a rectangular shape in a plan view. More specifically, a major axis of the substrate 100 may be parallel with a first direction, and a minor axis of the substrate 100 may be parallel with a second direction.

The memory chip 110 and the memory controller 120 may be mounted on one surface of the substrate 100. The memory chip 110 may have a chip-on-board package structure. The memory controller 120 may be electrically connected to the memory chip 110 to control overall operation of the memory chip 110.

It will be understood that a chip-on-board package structure can be mounted on a board without additional packaging which otherwise would be included if those structures were to be used in other applications where, for example, the structure is provided on a sub-mount, an intervening substrate, or other chip carrier to which the structure is mounted etc.

The memory chip 110 and the memory controller 120 may be disposed in various forms on the surface of the substrate 100. According to an exemplary embodiments of the inventive concept illustrated in FIG. 3A, the memory chip 110 may be disposed on the surface of the substrate 100 and may be electrically connected to the substrate 100 through first bonding wires 112. Further, the memory controller 120 may be vertically stacked on the memory chip 110 and may be electrically connected to the substrate 100 through second bonding wires 122, as illustrated in FIG. 3A.

According to another exemplary embodiment of the inventive concept illustrated in FIG. 3B, the memory chip 110 may be disposed on a front surface of the substrate 100 and may be electrically connected to the substrate 100 through the first bonding wires 112. Further, the memory controller 120 may also be disposed on the front surface of the substrate 100 to be laterally spaced apart from the memory chip 110, as illustrated in FIG. 3B. The memory controller 120 may be electrically connected to the substrate 100 through the second bonding wires 122, as illustrated in FIG. 3B.

According to still another exemplary embodiment of the inventive concept illustrated in FIG. 3C, the memory chip 110 may be mounted on the front surface of the substrate 100 using a flip chip bonding method and may be electrically connected to the substrate 100 through solder balls 114 or other conductive interconnect (without the use of the first bonding wires 112). The memory controller 120 may also be mounted on the front surface of the substrate 100 to be laterally spaced apart from the memory chip 110, as illustrated in FIG. 3C. The memory controller 120 may be electrically connected to the substrate 100 through the second bonding wires 122, as illustrated in FIG. 3C.

The portable data storage device may further include a molding portion 160 that covers the memory chip 110 and the memory controller 120. In addition, the portable data storage device may further include discrete elements, for example, resistors and/or capacitors on the front surface of the substrate 100. In some exemplary embodiments of the inventive concept, the molding portion 160 may fully encapsulate the memory controller 120 and the memory chip 110.

The first pads 130, the second pads 140 and the protruding terminals 150 may be disposed on a back surface of the substrate 100 opposite to the front surface.

The back surface of the substrate 100 may have a first region A1 in which the first pads 130 are disposed and a second region A2 in which the second pads 140 are disposed.

The first and second regions A1 and A2 may be located proximate to an end of the back surface of the substrate 100. For example, both the first and second regions Al and A2 may be located on one side of a straight line that passes through a central portion of the substrate 100 and extends in the second direction.

The first region A1 may be located at one end of the back surface of the substrate 100, and the second region A2 may be located between the first region A1 and the central portion of the substrate 100. The first and second regions A1 and A2 may be located to be adjacent to each other. In some embodiments according to the inventive concept, the first and second regions A1 and A2 are located directly adjacent to one another.

The first pads 130 may be arrayed in the first region A1 and may be spaced apart from each other in the second direction. Distances between the first pads 130 may be substantially equal to each other. The first pads 130 may be electrically connected to the core C of the substrate 100. For example, each of the first pads 130 may be directly connected to at least a portion of the metal layer 180 of the core C.

Each of the first pads 130 may have a bar shape extending in the first direction. The total number of the first pads 130 may be four according to a standard requirement of USB 2.0 devices. Two outer pads of the first pads 130 may be substantially longer than two inner pads of the first pads 130. However, shapes and sizes of the first pads 130 are not limited to the above descriptions.

The first pads 130 may be portions that are configured to substantially contact first terminals of a host when brought into contact therewith. Detailed explanations to the host will be mentioned in subsequent descriptions.

The second pads 140 may be arrayed in the second region A2 and may be spaced apart from each other in the second direction. Distances between the second pads 140 may be substantially equal to each other. The second pads 140 may be electrically connected to the core C of the substrate 100. For example, each of the second pads 140 may be directly connected to at least a portion of the metal layer 180 of the core C.

Each of the second pads 140 may have a bar shape extending in the first direction. The second pads 140 may be shorter than the first pads 130. The number of the second pads 140 may be five according to a standard requirement of USB 3.0 devices. However, shapes and sizes of the second pads 140 are not limited to the above descriptions.

The portable data storage device may further include an insulation layer 170 that covers the back surface of the substrate 100 and exposes the first and second pads 130 and 140. The insulation layer 170 may be a solder resist layer. The insulation layer 170 may prevent circuits on the substrate 100 from being deformed by an external impact and/or from being eroded by a chemical solution. Further, the insulation layer 170 may include a heat resistant material to endure heat generated from the circuits, the memory chip 110 and the memory controller 120 during operation of the portable data storage device.

In some embodiments according to the inventive concept, thicknesses of the first and second pads 130 and 140 may be substantially equal to each other. A thickness of the insulation layer 170 may be substantially equal to or greater than the thickness of the first and second pads 130 and 140.

The protruding terminals 150 may be disposed on respective ones of the second pads 140 opposite to the substrate 100. The protruding terminals 150 may have a configuration that supports the standard USB 3.0 devices. In some embodiments according to the inventive concept, the protruding terminals 150 may be solder balls. Each of the protruding terminals 150 may have a diameter W of about 0.9 mm to about 1.15 mm in a plan view. Each of the protruding terminals 150 may have a height H of about 0.5 mm to about 0.6 mm in a cross sectional view.

In some other exemplary embodiments according to the inventive concept, the regions in which the first and second pads 130 and 140 are disposed may not be limited to the first and second regions A1 and A2, and the numbers of the first and second pads 130 and 140 may not be limited to four and five. For example, at least two regions for the pads may be provided on the back surface of the substrate 100, and five or more first pads and six or more second pads may be disposed in three or more regions of the back surface of the substrate 100.

As described above, the protruding terminals 150 may be disposed on the second pads 140, thereby allowing improvement in the portability (i.e., compatibility) of the portable data storage device.

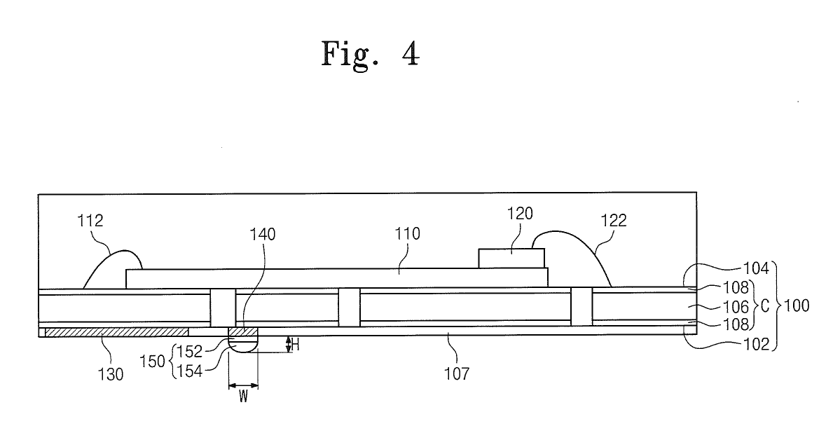

FIG. 4 is a cross sectional view illustrating a portable data storage device according to exemplary embodiments of the inventive concept.

Referring to FIG. 4, a portable data storage device according to the present exemplary embodiment may include a substrate 100, a memory chip 110, a memory controller 120, first pads 130, second pads 140 and protruding terminals 150.

The protruding terminals 150 may be arrayed to contact the second pads 140 that are disposed on a back surface of the substrate 100. Each of the protruding terminals 150 may have a structure that includes a first conductive layer 152 and a second conductive layer 154 are vertically stacked. The protruding terminals 150 of the portable data storage device according to the exemplary embodiments may also have a configuration that complies with the USB 3.0 standard to allow devices that also comply with the USB 3.0 standard to be operatively coupled thereto. The first conductive layer 152 may include solder paste. The second conductive layer 154 may include copper, copper alloy, doped silicon and/or nickel.

The first conductive layer 152 contacting the second pad 140 may have a diameter W of about 0.9 mm to about 1.15 mm in a plan view. Each of the protruding terminals 150 may have a total height H of about 0.5 mm to about 0.6 mm. The diameter W and the height H of the protruding terminals 150 may not be limited to the above dimensions. That is, the size of the protruding terminals 150 may be scaled down or enlarged according to a design scheme.

As described above, the second conductive layers 154 are disposed on the first conductive layers 152 opposite to the second pads 140, and the second conductive layers 154 include a relatively hard material. For example, in some embodiments according to the inventive concept, the second conductive layer 152 can include Sn, Ag and/or Cu. Thus, wear of the protruding terminals 150 may be reduced to prevent the failure of an electrical connection between the portable data storage device and a host. In addition, the protruding terminals 150 including the first and second conductive layers 152 and 154 may be formed to have the same height as the protruding terminals 150 including only the solder balls. Thus, the protruding terminals 150 including the first and second conductive layers 152 and 154 may still facilitate use of the portable data storage device.

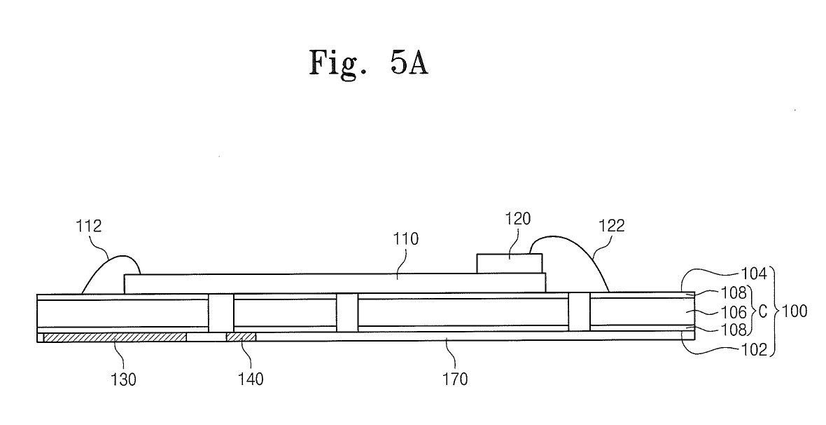

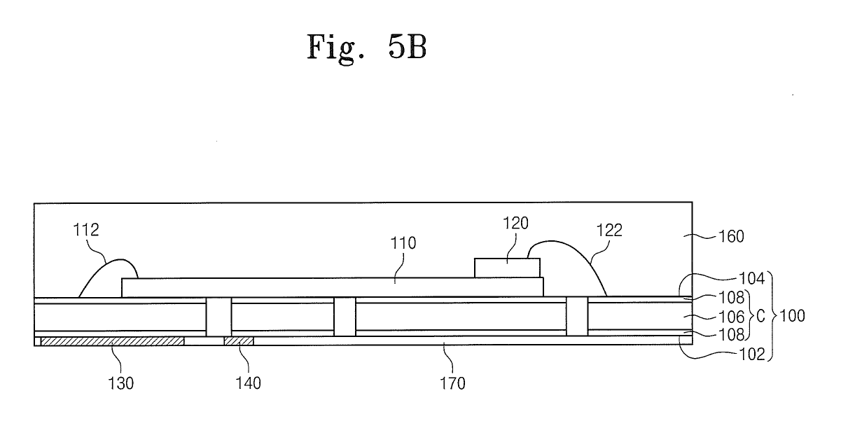

FIGS. 5A and 5B are cross sectional views illustrating methods of fabricating portable data storage devices according to exemplary embodiments of the inventive concept.

Referring to FIG. 5A, first pads 130 and second pads 140 may be formed on a back surface of a substrate 100, and a memory chip 110 and a memory controller 120 may be mounted on a front surface of the substrate 100 opposite to the back surface.

In some embodiments according to the inventive concept, the memory chip 110 may be disposed on the substrate 100, and the memory controller 120 may be disposed on the memory chip 110 opposite to the substrate 100. First bonding wires 112 may be formed to electrically connect the memory chip 110 to the substrate 100, and second bonding wires 122 may be formed to electrically connect the memory controller 120 to the substrate 100.

In some embodiments according to the inventive concept, the memory chip 110 and the memory controller 120 may be disposed on the front surface of the substrate 100 to be horizontally spaced apart from each other, and first bonding wires 112 and second bonding wires 122 may be formed (refer to FIG. 3B). The first bonding wires 112 may electrically connect the memory chip 110 to the substrate 100, and second bonding wires 122 may electrically connect the memory controller 120 to the substrate 100.

In still other embodiments according to the inventive concept, the memory chip 110 may be mounted on the front surface of the substrate 100 using a flip chip bonding method. The memory chip 110 may be electrically connected to the substrate 100 through solder balls 114 (refer to FIG. 3C). The memory controller 120 may be disposed on the front surface of the substrate 100, and bonding wires 122 may be formed to electrically connect the memory controller 120 to the substrate 100.

An insulation layer 170 may be formed on the back surface of the substrate 100. The insulation layer 170 may selectively expose the first pads 130 and the second pads 140.

Referring to FIG. 5B, a molding portion 160 may be formed on the front surface of the substrate 100 to cover the memory chip 110 and the memory controller 120. The molding portion 160 may include an epoxy molding compound (EMC) material.

In some embodiments according to the inventive concept, protruding terminals 150 may be formed on respective ones of the second pads 140, as illustrated in FIG. 3A, 3B or 3C. Each of the protruding terminals 150 may include a solder ball. In the event that each of the protruding terminals 150 is formed to include the solder ball, the fabrication processes may be easily performed.

In some embodiments according to the inventive concept, a first conductive layer 152 and a second conductive layer 140 may be sequentially formed on each of the second pads 154, as illustrated in FIG. 4. Briefly describing the processes for forming the first and second conductive layers 152 and 154, the first conductive layers 152 may be formed on respective ones of the second pads 140 using a solder paste and a screen printing method and the second conductive layers 154 may be formed on respective ones of the first conductive layers 152. The second conductive layers 154 may include a relatively hard material, such as Au, Cu and/or Ni. Thus, wear of the protruding terminals 150 may be reduced to prevent failure of an electrical connection between the portable data storage device and a host.

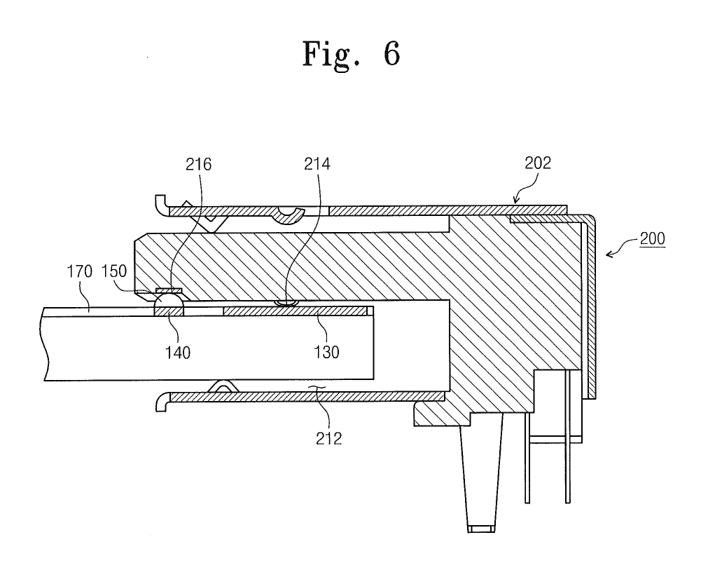

A configuration where the portable data storage device according to some exemplary embodiments of the inventive concept is combined with a host is described with reference to FIG. 6. The host may be an electronic system that can communicate with USB 3.0 compliant devices when operatively coupled thereto.

FIG. 6 is a cross sectional view illustrating a combined configuration where a portable data storage device according to an exemplary embodiment of the inventive concept is connected to the host.

Referring to FIG. 6, a host 200 may include a body 202, first terminals 214 and second terminals 216.

An empty space may be defined in the body 202 to provide a slot 212, and the slot 212 is spatially accessible to an outside space of the body 202. The portable data storage device according to some exemplary embodiments of the inventive concept may be inserted into the body 202 through the slot 212, thereby combining with the host 200.

When combined, the first terminals 214 and the second terminals 216 may be disposed on a top surface of the slot 212. The second terminals 216 may be disposed to be adjacent to an entrance of the slot 212, and the first terminals 214 may be disposed to be spaced apart from the entrance of the slot 212. That is, the second terminals 216 may be located between the entrance of the slot 212 and the first terminals 214.

The first terminals 214 may contact the first pads 130 of the portable data storage device when the portable data storage device is inserted into the slot 212. The first terminals 214 may include four pins according to a standard requirement of USB 2.0 devices, and distances between the first terminals 214 may be equal to each other.

The second terminals 216 may contact the protruding terminals 150 of the portable data storage device when the portable data storage device is inserted into the slot 212. The second terminals 216 may include five plates according to a standard requirement of USB 3.0 devices, and distances between the second terminals 216 may be equal to each other.

According to the exemplary embodiments set forth above, a receptacle (e.g., a slot) mounted in a host system can be standardized to support use of both USB 2.0 devices and USB 3.0 devices. Further, a portable data storage device, which is capable of combining with the standard slot for both the USB 2.0 devices and the USB 3.0 devices, can be provided.

Further, the portable data storage device includes protruding terminals disposed on second pads thereof, thereby more improving the portability (compatibility) of the portable data storage device. Each of the protruding terminals is formed to include a solder ball. Thus, the fabrication processes may be easily performed.

Moreover, each of the protruding terminals may include a relatively hard material. Thus, wear of the protruding terminals may be reduced to prevent failure of an electrical connection between the portable data storage device and the host system.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed:

1. A portable data storage device, the device comprising:
a substrate having a front surface on which a memory chip is mounted;
first pads disposed on a back surface of the substrate opposite to the front surface;
second pads disposed on the back surface of the substrate to be adjacent to the first pads; and
protruding terminals disposed on respective ones of the second pads opposite to the substrate.

2. The device of claim 1, wherein each of the protruding terminals includes a solder ball.

3. The device of claim 1, wherein each of the protruding terminals includes a first conductive layer and a second conductive layer on the first conductive layer.

4. The device of claim 3, wherein the first conductive layer includes a solder paste and the second conductive layer includes one of copper, copper alloy, nickel and/or doped silicon.

5. The device of claim 1, wherein each of the protruding terminals has a height of about 0.5 mm to about 0.6 mm above the back surface of the substrate.

6. The device of claim 1, wherein the first pads have a configuration that supports standard USB 2.0 devices.

7. The device of claim 1, wherein the protruding terminals have a configuration that supports standard USB 3.0 devices.

8. The device of claim 1, wherein the memory chip has a chip-on-board package structure.

9. The device of claim 1, further comprising:
a memory controller mounted on the front surface of the substrate and electrically connected to and spaced apart from the memory chip.

10. The device of claim 9 wherein the memory chip comprises a flip chip configuration.

11. The device of claim 9 wherein the memory chip and the memory controller are vertically stacked on one another.

12. The device of claim 1, wherein the substrate has a rectangular shape with a major axis parallel to a first direction and a minor axis parallel to a second direction in a plan view,
wherein the first pads are disposed to be spaced apart from each other in the second direction, and
wherein the second pads are disposed to be spaced apart from each other in the second direction.

13. A USB compliant portable data storage device comprising:
first pads disposed on a surface of the device configured to provide operative access to the device via a first USB standard;
second pads disposed on the surface of the substrate, adjacent to the first pads; and
protruding terminals, configured to protrude above the surface, disposed on respective ones of the second pads, configured to provide operative access to the device via a second USB standard.

14. The device of claim 13 wherein the first USB standard comprises a USB 2.0 standard and the second USB standard comprises a USB 3.0 standard.

15. The device of claim 13 wherein the protruding terminals protrude above the surface by a height in a range between about 0.5 mm and about 0.6 mm.

16. The device of claim 13 wherein the first pads are closer to a minor edge configured for insertion into a host slot of the device than the second pads.

17. The device of claim 13 wherein the protruding terminals comprise a hemispherical shape.

18. The device of claim 13 further comprising:
a memory chip on the substrate; and
a memory controller on the memory chip.

19. The device of claim 13 further comprising:
a memory chip on the substrate; and
a memory controller on the substrate spaced apart from the memory chip.

20. A multiple USB compliant host comprising:
a connector body defining a slot configured to allow insertion of a USB compliant portable data storage device including:
first pads disposed on a surface of the device configured to provide operative access to the device via a first USB standard;
second pads disposed on the surface of the substrate, adjacent to the first pads; and
protruding terminals, configured to protrude above the surface, disposed on respective ones of the second pads, configured to provide operative access to the device via a second USB standard, wherein the body further comprises:
protruding contacts configured to allow direct contact with respective ones of the first pads when the device is inserted into the slot; and
recessed contacts, positioned closer to an opening of the slot than the protruding contacts, the recessed contacts configured to allow direct contact with respective ones of the protruding terminals when the device is inserted into the slot.
